(19) United States
(12) Patent Application Publication
(10) Pub. No.: US 2021/0095514 A1
(43) Pub. Date: Apr. 1, 2021

(54) Intelligent Garage Door Opener System

(71) Applicant: Scott Madden, Tierra Verde, FL (US)

(72) Inventor: Scott Madden, Tierra Verde, FL (US)

(21) Appl. No.: 16/584,094

(22) Filed: Sep. 26, 2019

(51) Int. Cl. E05F 15/72; G08B 21/14; G07C 9/00; E04H 6/42

(52) U.S. Cl. CPC E05F 15/72; G08B 21/14; G07C 9/00896; E05Y 2900/106; G07C 2009/00928; E05Y 2800/42; E04H 6/42

(57) ABSTRACT

A method and apparatus for intelligently controlling a garage door opener from a wall controller includes measuring a concentration of a gas such as carbon monoxide in air around a garage door opener wall controller and if the concentration of gas is greater than a predetermined threshold for a predetermined period of time, determining a state of a garage door using digital imaging and if the state is an closed state, signaling the garage door opener associated with the garage door to open the garage door. In some embodiments, alerts are transmitted to a remote device indicating the presence of carbon monoxide and/or movement within the garage. In the latter, still and/or video images of the garage are also sent.

### FIELD

This invention relates to the field of garage door openers and more particularly to a system for managing opening and closing of a garage door from the remote door control.

### BACKGROUND

Garage door openers are generally a class of products having an electric motor that, when operated, moves a garage door from a closed position to an open position or from an open position to a closed position. Motorized garage door openers have been in use since their invention in 1926.

In early years, garage door openers were controlled by push button switches within the garage. Later, wireless remote controls were employed so one is able to open the garage door from their vehicle. The first wireless controls were simple radio frequency transmitters that transmitted short range signals on specific frequencies. These simple transmitters led to usage and security issues as it was easy to open another's garage door if their garage door remote was programed to be on the same frequency. Later, a coding system was used where each remote control transmitted a code based upon settings of a dip switch in the remote control matching settings of a dip switch in the garage door opener. This made it less likely that your remote control would open a neighbor's garage, but still had a security issue as the number of dip-switches was usually 8 or 12, providing 2⁸ or 2¹² total unique codes possible and easy to break.

In the 1990s, rolling codes became popular, in which, there were billions of combinations that changed each time the remote control is used. In such, each time a specific code is sent to the garage door opener, a new code is established for the next time that the garage door will be opened/closed. Therefore, even is the code is captured; it cannot be used again, as the next code is different.

Many safety features have been added to garage door openers to reduce injuries and possible death. Most of these safety features deal with injuries related to the garage door closing on someone, using force sensing or electric eyes to sense if something or someone is blocking closure of the garage door. These features have likely save many lives, especially lives of children who might be playing under a closing door.

One safety feature that has been slow to be adopted is carbon monoxide (CO) detectors. Carbon monoxide detectors typically sound an alarm when CO levels within the protected area (e.g. the garage) reach certain thresholds that are known to cause injury, illness, or death. Carbon monoxide is a colorless, odorless gas that combines with hemoglobin to produce carbonyl hemoglobin. The carbonyl hemoglobin usurps hemoglobin that normally carries oxygen to cells, but does not deliver oxygen, causing headaches, nausea, fatigue, and possibly death. In many countries of the world, carbon monoxide poisoning is the most common type of fatal air poisoning.

Carbon monoxide is created by combustion of a carbon-based fuel such as coal, gasoline, diesel, etc. Many people install carbon monoxide detectors near gas stoves and furnaces to warn of combustion fumes entering the living space, as those are normally vented outside of the home. One major produce of carbon monoxide in the home is a vehicle (e.g. car, truck, van). Many homes have attached garages. Further, the living spaces of many homes maintain an internal negative pressure, meaning that when a garage door is opened, the positive outside air pressure conducts air from the garage into the living spaces of the home, along with any carbon monoxide that is present in the air of the garage.

Carbon monoxide is slightly less dense than air, but not significantly less dense than air to quickly rise to ceiling levels. Therefore, in a garage having a source of carbon monoxide, the carbon monoxide will likely disperse throughout the entire garage.

Of course, leaving a running vehicle or generator running in a closed space such as a garage is never a good idea, but recently, several new products have created new possibilities for a possibly fatal mistake. For example, some vehicles have remote starters so one can start their car while finishing their morning chores, thinking they will very soon walk down to the garage and drive away, but a simple distraction like a long phone call might lead to forgetting the running car. Another new feature comes with hybrid cars that have a fossil fuel engine that charges the batteries when the batteries get to a certain charge level. Many hybrid vehicles have an electric mode that is silent, so when the driver enters the garage and stops, there is no noise to warn that the vehicle is still on. Later, after exiting the garage, when the batteries discharge to a certain point, the fossil fuel engine starts running, creating carbon monoxide. Also, some fossil fuel heating systems or water heaters are located in the garage. Should the exhaust flue be blocked, these devices will create excessive levels of carbon monoxide in the garage, where the home occupant might not realize the issue.

A few garage door openers are equipped with carbon monoxide sensors. U.S. Pat. No. 7,710,284 issued on May 4, 2010 to Dzurko et al., has a system for detecting and responding to carbon monoxide that is integrated or wired into the garage door opener motor controller. This requires that a homeowner remove their perfectly working garage door opener and replace it with one having carbon monoxide sensors or to make major electrical modifications to an existing garage door opener, something not recommended for those that are not licensed to perform electrical work. Further, the disclosed system will only monitor levels of carbon monoxide at the ceiling strata, not where people usually breath.

In a similar way, U.S. Pat. No. 7,183,993 issued on Feb. 27, 2007 to Dzurko et al., has a system for detecting an audible alarm from an external carbon monoxide detector and responding to the sounds. Again, this system is integrated or wired into the garage door opener motor controller. This system also has a mechanical sensor to detect if the garage door is closed so as to open the garage door upon detection of the sounds of the external carbon monoxide detector. This system also requires that a homeowner remove their perfectly working garage door opener and replace it, or to make major electrical modifications to an existing garage door opener, something not recommended for those that are not licensed to perform electrical work.

Further, the systems described above sense carbon monoxide levels near the garage door opener motor controller, but those who may be sickened by carbon monoxide are usually breathing air in the range of one foot to six feet above the garage floor, so it is more important to measure carbon monoxide levels within that range of heights.

U.S. Patent Publication No. 2006/0202815 published Sep. 14, 2006 to John describes a monitoring system for use with an existing garage door opener system. This system uses the wireless remote control signaling to attempt to open the garage door upon detection of carbon monoxide within the garage, but has no way to know if the garage door is already open and, therefore, if the garage door is open, this system will inadvertently close the garage door.

There is no solution presented or currently made that detects carbon monoxide, upon detection of sustained levels over a certain threshold, reliably open the garage door to allow the carbon monoxide to escape, remotely alert a user (as the user may not be in the garage, but another person/child may), provide video surveillance of the garage area, and be installable by a majority of home owners, at least as easy to install as a standard garage door opener wall control unit (no dangerous voltage potentials).

What is needed is a system that will install to an existing garage door opener system and open the garage door upon detection of certain concentrations of carbon monoxide.

### SUMMARY

In one embodiment, an intelligent wall controller for a garage door opener is disclosed a processor that has a gas sensor operatively coupled there to. The gas sensor measures a concentration of a gas (e.g. carbon monoxide) in the air around the intelligent wall controller. An electrically operated switch is operatively controlled by the processor for interfacing and controlling a garage door opener motor unit. A digital camera is operatively coupled to the processor and images from the digital camera are available for reading by the processor. Software running on the processor causes the processor to read the gas sensor and if the concentration of the gas is higher than a predetermined threshold (e.g. 400 ppm) for a predetermined period of time (e.g. 30 minutes), the software causes the processor to read one or more images from the digital camera and to determine from the one or more images if a garage door is closed and, if the garage door is closed, the software causes the processor to control the electrically operated switch to send a command to operate the garage door opener motor unit to move the garage door to an open position.

In another embodiment, a method of intelligently controlling a garage door opener from a wall controller is disclosed including measuring a concentration of a gas in air at the wall controller and if the concentration of gas is greater than a predetermined threshold for a predetermined period of time, determining a state of a garage door by analyzing images from a digital camera and if the state is an closed state, signaling the garage door opener associated with the garage door to open the garage door.

In another embodiment, an intelligent wall controller for a garage door opener is disclosed including a processor that has a carbon monoxide sensor operatively coupled there to. The carbon monoxide sensor measures a concentration of carbon monoxide in air around the intelligent wall controller. An electrically operated switch is operatively controlled by the processor and is electrically connected to a garage door opener motor unit. A digital camera is operatively coupled to the processor such that images from the digital camera are available for reading by the processor. Software running on the processor causes the processor to read the carbon monoxide sensor and if the concentration of the carbon monoxide is higher than a predetermined threshold (e.g. 400 ppm) for a predetermined period of time (e.g. 20 minutes), the software causes the processor to read one or more images from the digital camera and to determine from the one or more images if a garage door is closed. If the garage door is closed, the software causes the processor to control the electrically operated switch to send a command to operate the garage door opener motor unit to move the garage door to an open position.

The disclosed system monitors carbon monoxide at heights above and near the garage door floor where people generally breathe while maintaining the existing, perfectly functional garage door opener systems, preventing such from becoming land fill.

In some embodiments, alert messages are sent to a remote device (e.g. a smartphone) when carbon monoxide is detected, when movement is detected, and/or on command from the remote device.

In some embodiments, the disclosed system also monitors movement in the garage (or near the intelligent wall controller) and if/when there is movement, the disclosed system transmits images from the digital camera to a remote device and/or records the images from the digital camera.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a connection diagram of the system for intelligent garage door operation.

FIG. 2 illustrates a schematic view of the system for intelligent garage door operation.

FIG. 2A illustrated an exemplary implementation of the electrically operated switching device.

FIG. 3 illustrates a schematic view of a computer system in communications with the system for intelligent garage door operation.

FIG. 4 illustrates a schematic view of an exemplary device used with the system for intelligent garage door operation.

FIG. 5 illustrates a pictorial view of a garage door and garage door opener of the prior art.

FIG. 6 illustrates a pictorial view of a garage door and garage door opener and the system for intelligent garage door operation.

FIGS. 7-10 illustrate flow charts of the system for intelligent garage door operation.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

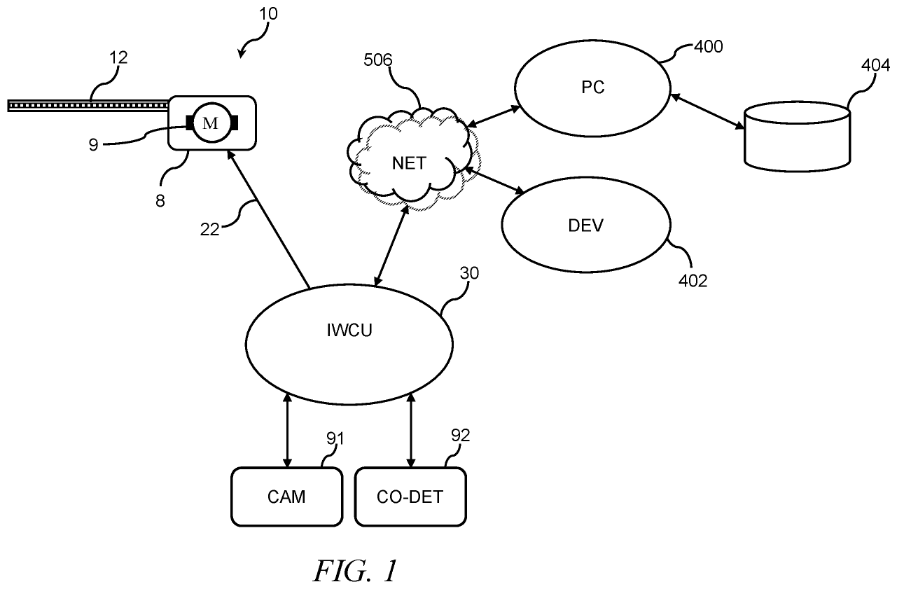

Referring to FIG. 1, a connection diagram of the system for intelligent garage door operation is shown. In this example, the intelligent wall controller unit 30 interfaces with a motor unit 8 of an existing (or new) garage door opener 10.

The motor unit 8 contains an electric motor 9. The electric motor 9 is chosen depending on the installation requirements. Anticipated motors 9 include alternating current motors of any voltage, for example, 120V or 240V. Further anticipated are direct current motors, including brushless motors, also referred to as electronically commutated motors.

The garage door opener 10 is shown in a simplified schematic view including only the rail 12 for brevity and clarity reasons. In this example, the intelligent wall controller unit 30 interfaces with a motor unit 8 through a wire interface 22 that is typically a two-wire or three-wire interface, standard for most garage door openers 10. It is equally anticipated that the intelligent wall controller unit 30 interfaces with a motor unit 8 through a wireless interface that is the same or similar to that used with wireless transmitters that control the garage door opener 10, usually from a vehicle or a wireless key-lock entry.

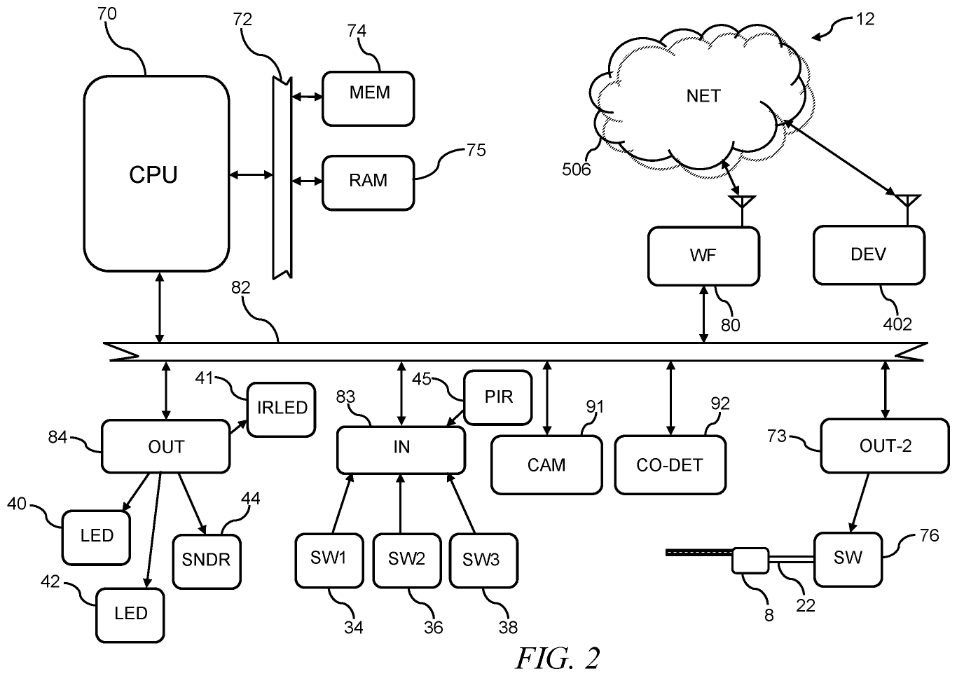

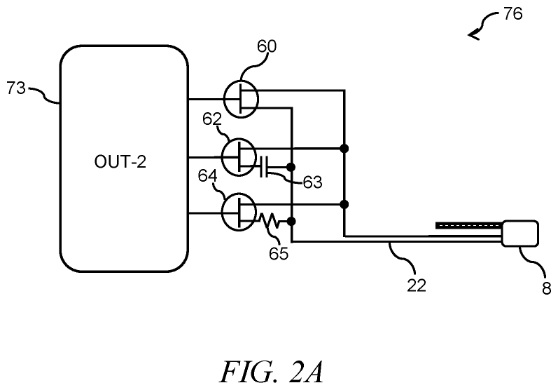

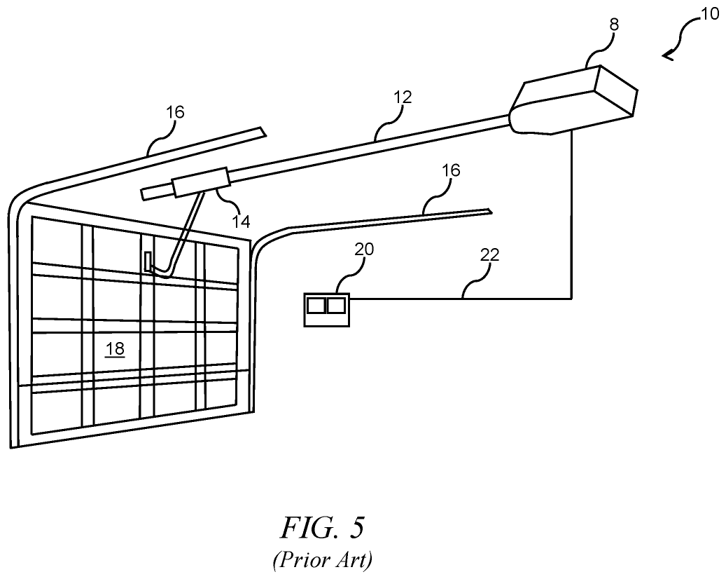

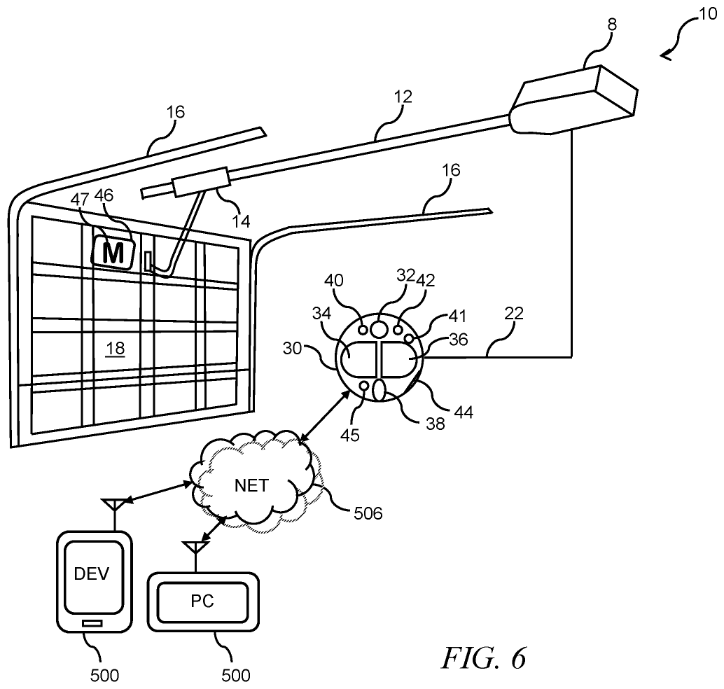

The intelligent wall controller unit 30 includes a carbon monoxide sensor 92 (or any sensor/sensor combination for detecting one or more gases such as carbon monoxide, methane, natural gas, and gasoline vapors) and a camera 91. Software running on a processor 70 (see FIG. 2) analyzes data from the carbon monoxide sensor 92 to determine levels of carbon monoxide that are present within the garage and utilized findings to determine when and if to initiate an alarm (e.g. a wireless alarm or sound emitted from a sounder 44) and/or automatically open the garage door 18 (see FIGS. 5 and 6). Most existing garage door openers 10 have a single open/close function, meaning that a user presses a single button once and the garage door 18 goes from closed to open if already closed or open to closed if already open. Pressing the same button again does the opposite. Because of this interface, the intelligent wall controller unit 30 requires knowledge of the current status (closed or not-closed) of the garage door 18, otherwise, if the garage door 18 is not closed (e.g. open or partially open) and the intelligent wall controller unit 30 detects a harmful level of carbon monoxide, the intelligent wall controller unit 30 would wrongly signal the motor unit 8 to close the garage door 18. To prevent such action, the intelligent wall controller unit 30 has a camera 91 that, among other things, visually determines a position of the garage door 18 (e.g. closed or not closed—e.g. open or partially open). Therefore if the intelligent wall controller unit 30 detects a dangerous concentration of carbon monoxide, before operating the garage door 18, the intelligent wall controller unit 30 utilized the camera 91 to determine the position of the garage door 18, and if the position of the garage door 18 is closed, the intelligent wall controller unit 30 signals the motor unit 8 to move the garage door 18 into the open position.

In some embodiments, the camera 91 provides motion detection features to determine when a person or animal moves in the garage. In some embodiments, an infrared sensor is provided to detect movement of a warm-blooded being within the garage.

In some embodiments, the intelligent wall controller unit 30 analyzes an image of the garage door 18 to determine if the garage door 18 is closed by recognizing the garage door 18 (as opposed to a view of outside the garage when the garage door 18 is not closed or open). As lighting in a garage is not often ideal for such recognition, especially at night, in a preferred embodiment, a detection sticker 46 (see FIG. 6) is placed on the garage door 18. The detection sticker 46 (or decal) preferably has a recognizable icon that is relatively easy for the intelligent wall controller unit 30 to recognize, even in low-light situations. In some embodiments, the detection sticker 46 has a unique icon 47 with high contrast. For example, a background color of the detection sticker 46 is black and the unique icon 47 is reflective (e.g. a reflector). By using a unique icon 47, the intelligent wall controller unit 30 is able to discern the detection sticker 46 from any other reflector (e.g. a bike reflector) within the garage with greater reliability.

In some embodiments, the intelligent wall controller unit 30 is operatively coupled to a network 506 (e.g. a wireless network such as cellular or Wi-Fi). Through the network 506, the intelligent wall controller unit 30 communicates with other entities such as a personal computer 400 or a device 402 (e.g. smartphone or tablet). In such, the intelligent wall controller unit 30 has features that will send wireless transactions indicating alerts to such devices that include when high levels of carbon monoxide are detected, but also, when the garage door 18 is open or partially open for too long or during time periods in which the garage door 18 is not expected to be open or partially open. For example, if everyone from the family is at work/school from 8 AM to 5 PM, then it is expected that the garage door 18 be closed during such period. If the intelligent wall controller unit 30 detects the garage door 18 being not closed (e.g. open or partially open) for more than a few minutes during that period, the intelligent wall controller unit 30 signals, through the network 506) such status, as it is likely that someone inadvertently left the garage door in a position that is not closed such as partially open or open. In response to this signal, a return signal from, for example, the device 402, initiates closure of the garage door 18. In some embodiments, the intelligent wall controller unit 30 is programmed and setup to automatically close the garage door 18 when the garage door 18 being in a non-closed position (e.g. open) for more than a few minutes during a period that the homeowners are expected to be away.

In some embodiments, the intelligent wall controller unit 30 also transmits logging information, for example, to the personal computer 400 for retention in a storage device 404. For example, periodically, an average carbon monoxide level is transmitted to the personal computer 400 and logged in the storage device 404. Later, a graph of the average carbon monoxide levels is presented at the personal computer 400 for the homeowner to understand how much exposure to carbon monoxide is present.

Referring to FIG. 2, a schematic view of the system for intelligent garage door operation is shown. The intelligent wall controller unit 30 shown represents a typical processor-based system, though the same or similar functionality is anticipated using logic in place of any or the entire device shown. This exemplary intelligent wall controller unit 30 is shown in its simplest form. Different architectures are known that accomplish similar results in a similar fashion, and the present invention is not limited in any way to any particular system architecture or implementation. In this intelligent wall controller unit 30, a processor 70 executes or runs programs in a random access memory 75. The programs are generally stored within a persistent memory 74 and loaded into the random access memory 75 when needed. The processor 70 is any processor, typically a processor designed for low power operation. The persistent memory 74 and random access memory 75 are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data and program instruction, for example, flash memory, read only memory, battery-backed memory, etc. In some intelligent wall controller units 30, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a wireless network interface 80 (e.g. Wi-Fi), an output port 84 for driving the status indicators 40/42 and for driving a sounder 44, and an input port 83 for reading inputs from switches 34/36/38, though there is no restriction on inputs and outputs. In some embodiments, a passive infrared sensor (PIR) 45 is also connected to the input port 83. The passive infrared sensor (PIR) 45 senses movement within the garage and, in some embodiments, triggers an alert (e.g. emitting sounds from a sounder 44 and/or transmitting a wireless signal indicating the alert).

In general, some portion of the persistent memory 74 is used to store programs, executable code, and data, etc.

The peripherals are examples, and other devices are known in the industry, the details of which are not shown for brevity and clarity reasons.

The wireless network interface 80 connects the intelligent wall controller unit 30 to a network 506 (e.g. a local area wireless network or the cellular network) through any known or future protocol such as WI-FI, GSM, TDMA, LTE, etc. There is no limitation on the type of connection used. The wireless network interface 80 provides data and messaging connections between the intelligent wall controller unit 30 and personal computers 400 or devices 402.

The intelligent wall controller unit 30 includes a carbon monoxide sensor 92 and a camera 91, optionally having a one or more infrared LEDs 41 for viewing during darkness (e.g. at night and when the garage door is closed). Software running on a processor 70 analyzes data from the carbon monoxide sensor 92 to determine levels of carbon monoxide that are present within the garage and utilized findings to determine when and if to initiate an alert (e.g. emitting sounds from a sounder 44 and/or transmitting a wireless signal indicating the alert) and/or automatically open the garage door 18. Most existing garage door openers 10 have a single open/close function, meaning that a user presses a single button once and the garage door 18 goes from closed to open if already closed or open (or partially open) to closed if already open (or partially open). Pressing the same button again does the opposite. Because of this open/close interface, the intelligent wall controller unit 30 requires knowledge of the current status (open, partially open, or closed) of the garage door 18, otherwise, if the garage door 18 is not closed and the intelligent wall controller unit 30 detects a harmful level of carbon monoxide, the intelligent wall controller unit 30 would wrongly signal the motor unit 8 to close the garage door 18. To prevent such action, the intelligent wall controller unit 30 has a camera 91 that, among other things, visually determines a position of the garage door 18 (e.g. open, closed, and partially open), in some embodiments when the garage is dark by illuminating the infrared LED(s) 41. Therefore if the intelligent wall controller unit 30 detects a dangerous concentration of carbon monoxide, before operating the garage door 18, the intelligent wall controller unit 30 utilized the camera 91 to determine the position of the garage door 18, and if the position of the garage door 18 is closed, the intelligent wall controller unit 30 signals the motor unit 8 to move the garage door 18 into the open position.

In some embodiments, the intelligent wall controller unit 30 analyzes an image of the garage door 18 to determine if the garage door 18 is closed by recognizing the garage door 18 (as opposed to a view of outside the garage when the garage door 18 is open or partially open). As lighting in a garage is not often ideal for such recognition, especially at night, in a preferred embodiment, a detection sticker 46 (see FIG. 6) is placed on the garage door 18. The detection sticker 46 (or decal) preferably has a recognizable icon that is relatively easy for the intelligent wall controller unit 30 to recognize, even in low-light situations, though visibility is optionally enhanced by the infrared LED(s) 41. In some embodiments, the detection sticker 46 has a unique icon 47 with high contrast. For example, a background color of the detection sticker 46 is black and the unique icon 47 is reflective. By using a unique icon 47, the intelligent wall controller unit 30 is able to discern the detection sticker 46 from any other reflector (e.g. a bike reflector) within the garage with greater reliability.

In some embodiments, the intelligent wall controller unit 30 is operatively coupled to a network 506 (e.g. a wireless network such as cellular or Wi-Fi). Through the network 506, the intelligent wall controller unit 30 communicates with other entities such as a personal computer 400 or a device 402 (e.g. smartphone or tablet). In such, the intelligent wall controller unit 30 has features that will send wireless alerts to such devices that include when high levels of carbon monoxide are detected, but also, when the garage door 18 is open (or partially open) for too long or during time periods in which the garage door 18 is expected to be closed. In some embodiments, the camera 91 is also used to capture images and/or video of what is happening in the garage. In such, the images/video is transmitted to the personal computer 400 and/or device 402 through the wireless network interface 80 and network 506 for viewing and/or storage.

For wired control of the garage door opener 10, an output port 73 interfaces with an electrically operated switching device 76. This electrically operated switching device 76 presents the requisite signaling impedances onto the two (or three) wire interface 22 that connects to the motor unit 8 of the garage door opener 10. For example, under control of software running on the processor 70, the electrically operated switching device 76 presents either a short across the wire interface 22 (signaling open/close of the garage door 18), a 1 uF capacitance (signaling turn on/off the light), or a 22 uF capacitance (signaling blocking or unblocking of wireless transmitters).

Referring to FIG. 2A, an exemplary implementation of the electrically operated switching device 76 is shown. In this example, the output port 73 interfaces with three electrical switching devices 60/62/64. In this example, the electrical switching devices 60/62/64 are shown as field-effect transistors, though any electrical switching device is anticipated including, not limited to transistors and relays. Each electrical switching devices 60/62/64 present the requisite signaling impedances onto the two (or three) wire interface 22 that connects to the motor unit 8 of the garage door opener 10. For example, under control of software running on the processor 70, a first electrical switching device 60 presents either an open (high impedance) or a short (low impedance) across the wire interface 22, signaling open/close of the garage door 18; a second electrical switching device 62 presents either an open (high impedance) or a capacitance 63 (e.g., a 1 uF capacitor), signaling turn on/off the light; a third electrical switching device 64 presents either an open (high impedance) or a resistance 65 (e.g., a 180 ohm resistor), signaling blocking or unblocking of wireless transmitters.

Note that in some embodiments a capacitor is used in place of the resistance 65. Likewise, in some embodiments, a resistor is used in place of the capacitance 63.

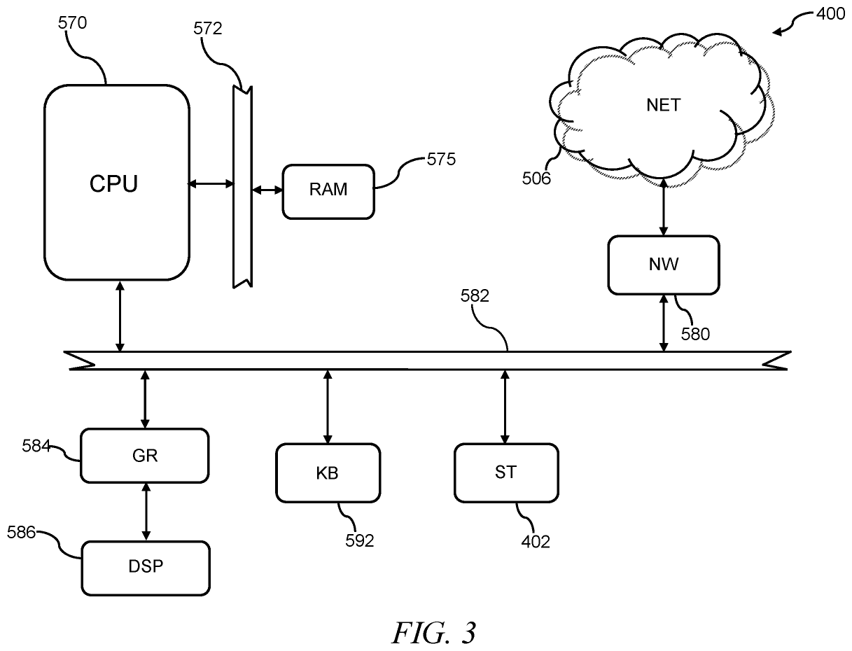

Referring to FIG. 3, a schematic view of a personal computer 400 that is optionally in communications with the system for intelligent garage door operation is shown. The example of a personal computer 400 represents a typical personal computer 400 used in the system for intelligent garage door operation. This exemplary personal computer 400 is shown in its simplest form. Different architectures are known that accomplish similar results in a similar fashion and the present invention is not limited in any way to any particular computer system architecture or implementation. In this exemplary personal computer 400, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The storage device 404 is any type, configuration, capacity of memory suitable for persistently storing data, for example, magnetic storage, flash memory, read only memory, battery-backed memory, magnetic memory, etc. The storage device 404 is typically interfaced to the processor 570 through a system bus 582, or any other interface as known in the industry.

Also shown connected to the system bus 582 is a network interface 580 (e.g., for connecting to the network 506), a graphics adapter 584 and a keyboard interface 592 (e.g., Universal Serial Bus—USB). The graphics adapter 584 receives information from the processor 570 and controls what is depicted on a display 586. The keyboard interface 592 provides navigation, data entry, and selection features.

In general, some portion of the storage in the storage device 404 is used to store programs, executable code, data, contacts, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

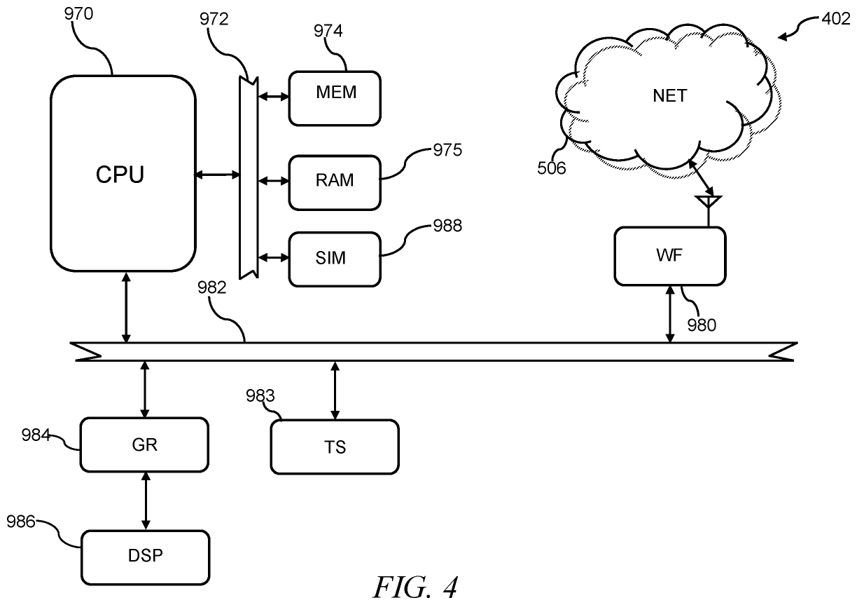

Referring to FIG. 4, a schematic view of an exemplary device 402 used with the system for intelligent garage door operation is shown. The exemplary device 402 is a processor-based device for providing command, data and control through the network 506 to the system for intelligent garage door operation. The present invention is in no way limited to any particular device 402 and many other devices are anticipated that offer similar connectivity. An example of such device 402 is a smartphone, a smart watch, or a tablet computer.

The device 402 represents a typical device for providing command, data and control through the network 506 to the system for intelligent garage door operation (any data network is anticipated including, but not limited to, Wi-Fi, CDMA, GSM, TDMA, LTE, etc.) This exemplary device 402 is shown in its simplest form. Different architectures are known that accomplish similar results in a similar fashion, and the present invention is not limited in any way to any particular system architecture or implementation. In this exemplary device 402, a processor 970 executes or runs programs in a random access memory 975. The programs are generally stored within a persistent memory 974 and loaded into the random access memory 975 when executed. A subscriber identity module 988 (SIM or SIM card) securely stores an international mobile subscriber identity (IMSI) number and its related key, which are used to identify and authenticate subscribers on the cellular network. The processor 970 is any processor, typically a processor designed for data communications. The persistent memory 974, random access memory 975, and subscriber identity module 988 are connected to the processor by, for example, a memory bus 972. The random access memory 975 is any memory suitable for connection and operation with the selected processor 970, such as SRAM, DRAM, SDRAM, RDRAM, DDR, DDR-2, etc. The persistent memory 974 is any type, configuration, capacity of memory suitable for persistently storing data, for example, flash memory, read only memory, battery-backed memory, etc.

Also connected to the processor 970 is a system bus 982 for connecting to peripheral subsystems such as a network interface 980 (e.g. Wi-Fi or cellular interface). Typically, a graphic controller 984 is provided for driving a display 986, and a touch sensor 983 is provided for accepting user inputs through a touch screen of the display 986, though there is no restriction on inputs and outputs.

In general, some portion of the persistent memory 974 is used to store programs, executable code, and data, etc.

The peripherals are examples, and other devices are known in the industry are anticipated, the details of which are not shown for brevity and clarity reasons.

In some embodiments, a user interface of the personal computer 400 and/or the device 402 provides setup, configuration, and control to the intelligent wall controller unit 30. For example, even though no button is included on the intelligent wall controller unit 30 for locking (e.g. preventing remote control transmitters from communicating with the motor unit 8 to open/close the garage door 18), in some embodiments, the user interface has a lock feature that sends a signal to the intelligent wall controller unit 30 through the network 506 and, responsive to that signal, the intelligent wall controller unit 30 presents the associated impedance over the two wire interface 22, locking/unlocking the motor unit 8. Note that in some embodiments, the intelligent wall controller unit 30, recognizing the locked state, will signal an alert (e.g. emit sounds from sounder 44 and/or transmit a wireless signal indicating the alert) should the motor unit 8 be controlled to open the garage door 18.

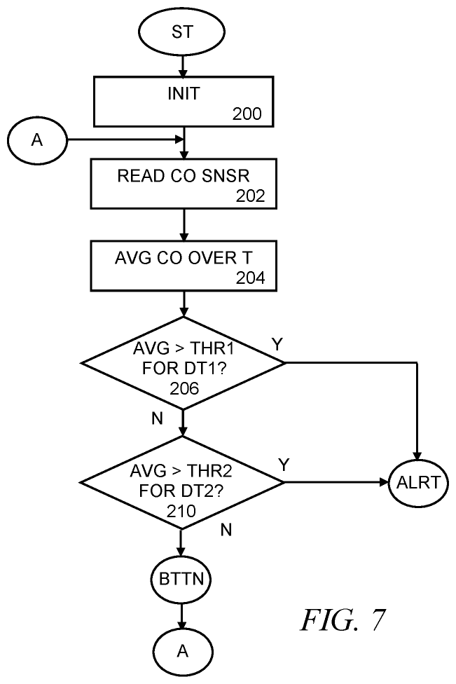

In some embodiments, the user interface controls wireless alert features such as setting of which device(s) will receive the wireless alerts, etc. In some embodiment, the user interface also provides settings to modify one or more carbon monoxide thresholds (see FIG. 7).

In some embodiments, the user interface has features to open/close each garage door, in tandem or independently. In some embodiments, a user interface with a security code is provided to a visitor, allowing a single garage access, garage access for a period of time, and/or garage access until revoked.

Referring to FIG. 5, a pictorial view of a garage door 18 and garage door opener 10 of the prior art is shown. Although many different types of garage door openers are known, including different drive mechanisms (belt drive, screw drive, chain drive, etc.) for overhead garage doors 18 as well as garage door openers for hinged garage doors (swinging), etc., for brevity and clarity reasons the remainder of this disclosure will use an overhead garage door 18 and related garage door opener 10 as an example, thought the described system and solution is fully anticipated for all types of garage door openers 10.

In the example of the prior art shown in FIG. 5, a simplified garage door 18 is shown having tracks 16 on which rollers (not shown) of the garage door 18 traverse when the garage door 18 is lifted/lowered. As the garage door 18 is often heavy, maybe too heavy to be lifted by a person, there is often a counter balance mechanism that works against such weight to allow most people to open the garage door 18 by hand. This counter balance mechanism is often a torsion spring and cable system that biases the garage door 18 and counter balances the weight of the garage door 18. The counter balance mechanism is not shown for brevity and clarity reasons and because there are multiple counter balance systems, all of which are fully anticipated to fully operate with the disclosed invention.

The garage door opener 10 of the prior art has a motor unit 8 that is typically affixed to the ceiling of the garage. The motor unit 8 includes a motor and electronics for controlling operation of the motor responsive to either a wall control unit 20 or a wireless transmitter (not shown for brevity and clarity reasons). The wall control unit 20 is wired to the motor unit 8, typically using the wire interface 22 (e.g. two wires). The wall control unit 20, through a signaling arrangement over the wire interface 22, typically has two or three buttons that control initiation of the motor unit 8 to operate the motor to lift/lower the garage door 18 as well as to manually illuminate a lamp associated with the motor unit and/or to place a vacation-lock on the garage door opener 10 (disallowing operation of the wireless transmitters). In some scenarios, the wall control unit 20 has a single button that control initiation of the motor unit 8 to operate the motor to lift/lower the garage door 18.

In this example, when the wall control unit 20 (or wireless transmitter) is operated to initiate operation of the motor within the motor unit 8, the motor turns in one direction, moving a trolley 14 along a rail 12 to lift/lower the garage door 18 along the tracks 16.

Referring to FIG. 6, a pictorial view of a garage door 18 and garage door opener 10 equipped an intelligent wall controller unit 30 with is shown. Again, although many different types of garage door openers are known, including different drive mechanisms (belt drive, screw drive, chain drive, etc.) for overhead garage doors 18 as well as garage door openers for hinged garage doors (swinging), etc., for brevity and clarity reasons this disclosure uses an exemplary overhead garage door 18 and related garage door opener 10 as an example, thought the described system and solution is fully anticipated for all types of garage door openers 10.

The intelligent wall controller unit 30 replaces or supplements the wall control unit 20 of the prior art without modification to the existing motor unit. This is important, as many typical homeowners are able to replace the wall control unit 20 with the intelligent wall controller unit 30, as only a few screws are used to physically mount either and the two wire interface 22 carries only low voltages that are not dangerous.

Once the replacement is made, the intelligent wall controller unit 30 is interfaced to the existing motor unit 8 through the wire interface 22 (typically two or three wires). The intelligent wall controller unit 30, through a signaling arrangement over the wire interface 22, typically has two or three switches 34/36/38 (e.g. momentary contact or touch sensitive). A first switch 34 controls initiation of a first motor unit 8 to operate the motor to lift/lower a first garage door 18. A second switch 36 controls initiation of a second motor unit (not shown) to operate the motor to lift/lower a second garage door 18 (not shown) as many homes have two garage doors 18. A third switch 38 illuminates lights of the motor unit 8. In some scenarios, the intelligent wall controller unit 30 supplements other wall control units 20 or a single button that also controls initiation of the motor unit 8.

In some embodiments, operation of the first switch 34 and/or the second switch 36 by double tapping or double clicking initiates operation of the motor to lift/lower the garage door 18 after a preset delay (e.g. two minutes to two hours).

In some embodiments, the intelligent wall controller unit 30 includes status indicators 40/42 (e.g. LEDs). One status indicator 40 indicates status of a level of carbon monoxide was detected (e.g. an alert) and one status indicator 42 indicates status of a wireless connection.

In this example, when the intelligent wall controller unit 30 is operated to initiate operation of the motor within the motor unit 8, the motor turns in one direction, moving a trolley 14 along a rail 12 to lift/lower the garage door 18 along the tracks 16.

As described with FIG. 2, the intelligent wall controller unit 30 includes a carbon monoxide sensor 92 and software to determine when carbon monoxide levels within the garage reach dangerous levels.

In some embodiments, the intelligent wall controller unit 30 communicates with a remote device 402 or computer 400 through a network 506 for remote monitory and control. It is anticipated that any current of future network technology and/or topology be used, including, but not limited to, Wi-Fi, local area networks, wide area networks, cellular networks; along with any required networking devices such as routers and bridges. In some such embodiments, history data is recorded by the intelligent wall controller unit 30 and/or a remote device 402 or computer 400. In some such embodiments, the data includes video/still images, carbon monoxide readings, open/close events, movement events (e.g. movement detected by the camera 91 and/or the passive infrared sensor (PIR) 45), etc. In some embodiments, the remote device 402 includes software (e.g. an application) that provides control and setup of the intelligent wall controller unit 30 as well as reception of alerts and events from the intelligent wall controller unit 30, including viewing of the data (e.g. forward, pause, play, and back operations). In some embodiments, the application provides “quick call” emergency numbers such that, selecting one of the “quick call” icons, cases the remote device 402 to automatically dial a phone number associated with that icon, for example, police, fire, ambulance, and other (e.g. programmed to call a neighbor). This is useful as when the homeowner is out of town and they receive an alert message, dialing of 911 results in reaching local emergency call centers to where the homeowner is rather than where the home is located.

Referring to FIGS. 7-10, flow charts of the system for intelligent garage door operation is shown. The following describes a sample software operation of the intelligent wall controller unit 30, running on the processor 70. It is fully anticipated that other similar or different software operation and organization will function in a similar way, providing the claimed functionality of the intelligent wall controller unit 30, all of which are included here within.

In the example, program flow begins with initialization 200, connecting to the network, resetting any alerts, and setting the status indicators 40/42 for normal operation (green status for connected to the network and carbon monoxide indicator extinguished).

Now a loop begins (A) with reading 202 the carbon monoxide sensor 92 and creating an average carbon monoxide level over time 204. Note that in this embodiment, in order to signal an alert (e.g. emit sounds from sounder 44 and/or transmit a wireless signal indicating the alert), concentrations of carbon monoxide (readings from the carbon monoxide sensor 92) must average over predetermined thresholds for a period of time. For example, an average of 400 parts per million of carbon monoxide over a period of 20 minutes is measured or 200 parts per million of carbon monoxide over a period of 40 minutes. It is fully anticipated that in some embodiments, an absolute reading (e.g. any measurement of carbon monoxide over 400 parts per million) will trigger an alert (e.g. emit sounds from sounder 44 and/or transmit a wireless signal indicating the alert), though such might be problematic should a person or animal (emitters of carbon monoxide) breath near the carbon monoxide sensor 92.

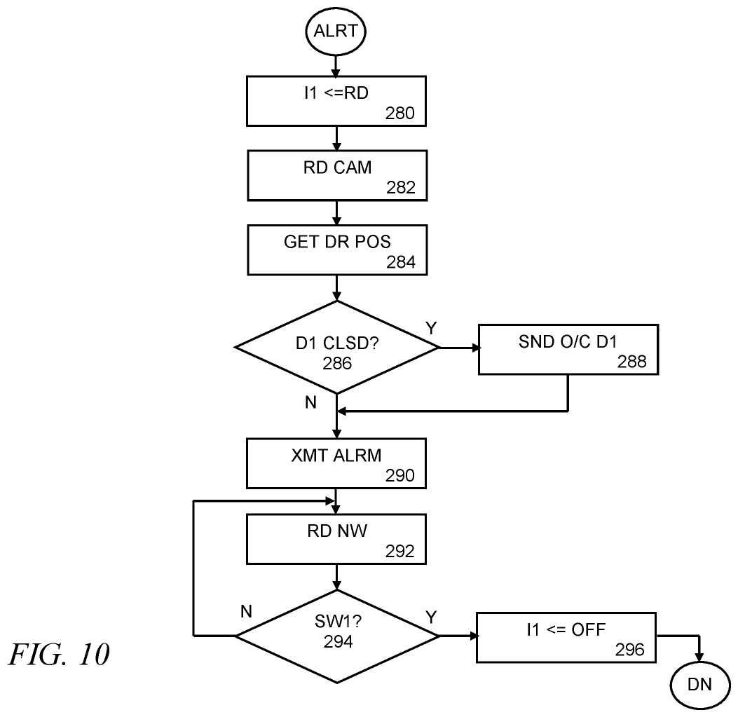

If this average carbon monoxide concentration for a first period of time is greater than a first threshold 206 (e.g. the average concentration is greater than 400 parts per million, the first threshold, for longer than 20 minutes, the first period of time), then the alert function is initiated (see FIG. 10). Likewise, if this average carbon monoxide concentration for a second period of time is greater than a second threshold 210 (e.g. the average concentration is greater than 200 parts per million, the second threshold, for longer than 40 minutes, the second period of time), then the alert function is initiated (see FIG. 10). Note that the threshold values and time periods are realistic, but shown as examples as any threshold and/or time period is anticipated. By setting the time period to zero, the alert is signaled if any reading of the carbon monoxide sensor 92 is over the associated threshold.

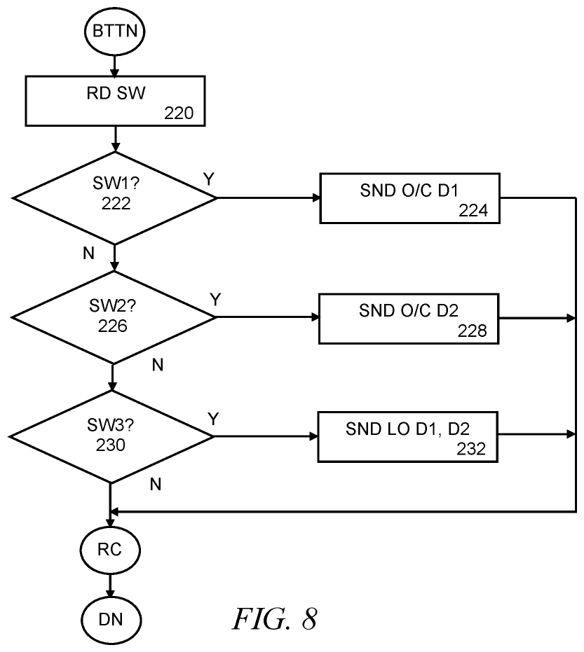

If no alert is initiated, a routine (BUN), as described in FIG. 8, is run to check for any operating commands.

Referring to FIG. 8, a routine to check for button presses is shown, as there are several push button switches (or any type of switch including capacitive switches) on the intelligent wall controller unit 30 such as a first switch 34 for commanding a first motor unit 8 to open/close a first associated garage door 18, a second switch 36 for commanding a second motor unit 8 to open/close a second associated garage door 18, and a third switch 38 for illuminating/extinguishing a lamp associated with either the first motor unit 8 and/or the second motor unit 8. Note that the flow shown is a polling algorithm, while it is also anticipated that pressing of a switch 34/36/38 interrupts the processor 70 or any switch interface as known in the industry.

If the first switch 34 (for commanding a first motor unit 8) is pressed 222, the software initiates sending 224 of an open/close command to the first motor unit 8. If the second switch 36 (for commanding a second motor unit 8) is pressed 226, the software initiates sending 228 of an open/close command to the second motor unit 8. If the third switch 38 (for commanding lights on/off) is pressed 230, the software initiates sending 232 of a lights on/off command to the first motor unit 8 and/or the second motor unit 8. Note that in some embodiments, more or less switches are present. For example, it is fully anticipated that the intelligent wall controller unit 30 be absent of the third switch 38 for commanding lights on/off or include a fourth switch so that the third switch commands lights on/off for the first motor unit 8 and the fourth switch commands lights on/off for the second motor unit 8. Not also, it is fully anticipated that in some embodiments, only one motor unit 8 is present and, in some embodiments, the intelligent wall controller unit 30 is configured to operate with only one motor unit 8 (e.g. there is no second switch 36).

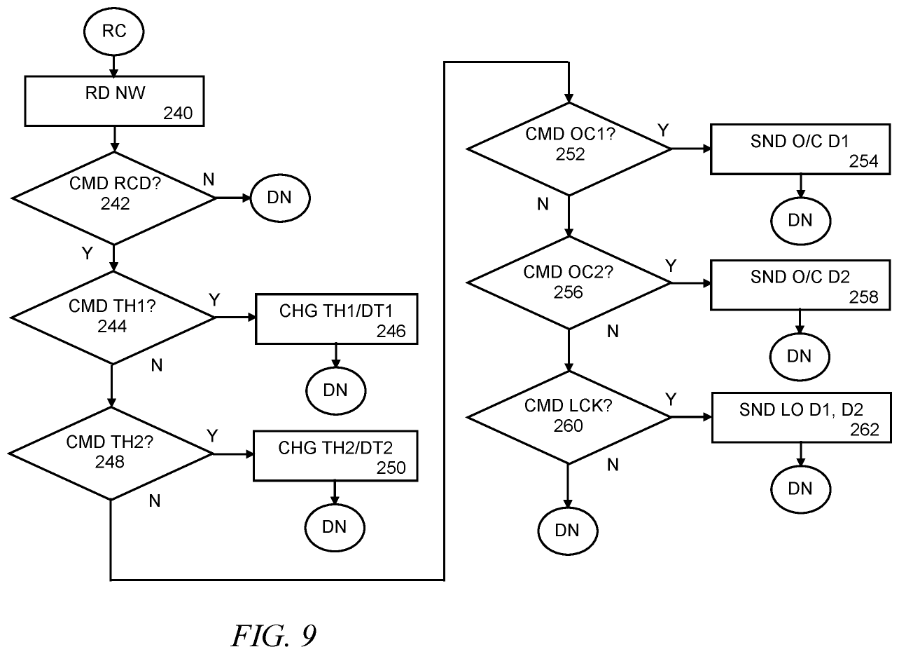

After checking for switch activity, tests are made for remote commands as shown in FIG. 9.

In FIG. 9, the wireless network interface 80 is read 240 to see if there are any commands from remote devices (e.g. a personal computer 400 or device 402). If no command was received 242, flow returns back and the loop above repeats.

If a change command 244 is received to change the first threshold, the first threshold (TH1) and time period (DT1) are changed as per the command and the loop above repeats. If a change command 248 is received to change the second threshold, the second threshold (TH2) and time period (DT2) are changed as per the command and the loop above repeats.

If an open/close 252 of a first garage door 18 is received, the software initiates sending 254 of an open/close command to the first motor unit 8 and the loop above repeats. If an open/close 256 of a second garage door 18 is received, the software initiates sending 258 of an open/close command to the second motor unit 8 and the loop above repeats. If a lock command 260 is received, the software initiates sending 262 of a lock command to the first motor unit 8 and/or the second motor unit 8 and the loop above repeats. Note that the above represents a sample of remote commands that are anticipated for the intelligent wall controller unit 30 and it is fully anticipated that any number of remote commands be implemented, including zero remote commands.

In FIG. 10, a routine for alert initiation is shown (ALRT). In this, the alarm status indicator 40 is illuminated 280 to indicate a level of carbon monoxide was detected (e.g. blinking red). Now the camera 91 is read 282 and the image is analyzed to determine the position 284 of the garage door 18 (or doors). As it is not wanted to close an open garage door 18 when high levels of carbon monoxide are detected, only if it was determined that the garage door 18 is closed, will an open/closed command be sent 288 to the motor unit 8 (note that this is simplified as in some embodiments, there are two motor control units 8).

Now that the garage door(s) 18 are open, an alert is initiated either by emitting sounds from sounder 44 and/or transmitting a wireless signal indicating the alert 290 (e.g. through the wireless network interface 80) to, for example, a personal computer 400 and/or device 402.

Now, the alert mode remains with the garage door(s) 18 open until reading the wireless network interface 80 and receiving a command 292 to stop the alert. If the command 292 to stop the alert is received 294, the alarm status indicator 40 is extinguished 296 (and sound abated) and the loop continues. Note that in some embodiments, the garage door(s) 18 is/are returned to the state they were in before the alarm occurred or, is some embodiments, a command must be received to close each garage door 18, either separate or in tandem.

In the above program flows, when commands are sent to the motor units 8, the commands are sent either by controlling the electrically operated switch (as described above) or by emitting an appropriate radio frequency transmission from a transmitter that is programmed and paired to wirelessly open/close the garage door opener(s) 10.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An intelligent wall controller for a garage door opener comprising:
a processor;
a gas sensor operatively coupled to the processor, the gas sensor measures a concentration of a gas in air around the intelligent wall controller;
an electrically operated switch operatively controlled by the processor, the electrically operated switch for interfacing to a motor unit of the garage door opener;
a digital camera operatively coupled to the processor, images from the digital camera are available for reading by the processor;
software running on the processor causes the processor to read the gas sensor and if the concentration of the gas is higher than a predetermined threshold for a predetermined period of time, the software causes the processor to read one or more images from the digital camera and to determine from the one or more images if a garage door is closed and, if the garage door is closed, the software causes the processor to control the electrically operated switch to send a command to operate the motor unit of the garage door opener to move the garage door to an open position.

2. The intelligent wall controller for the garage door opener of claim 1, wherein the gas is selected from the group consisting of carbon monoxide, methane, and natural gas.

3. The intelligent wall controller for the garage door opener of claim 1, wherein the software causes the processor to determine from the one or more images if the garage door is closed by way of a position of a sticker that is attached to an inside surface of the garage door.

4. The intelligent wall controller for the garage door opener of claim 1, further comprising a switch, the software causes the processor to detect an operation of the switch and upon detecting the operation of the switch, the software causes the processor to control the electrically operated switch to send the command to operate the motor unit of the garage door opener to move the garage door to an opposing position.

5. The intelligent wall controller for the garage door opener of claim 1, wherein the predetermined period of time is zero.

6. The intelligent wall controller for the garage door opener of claim 2, wherein the predetermined threshold is 200 parts per million and the predetermined period of time is thirty minutes.

7. The intelligent wall controller for the garage door opener of claim 2, wherein the predetermined threshold is 400 parts per million and the predetermined period of time is twenty minutes.

8. The intelligent wall controller for the garage door opener of claim 1, further comprising a wireless network interface, the wireless network interface is operatively coupled to the processor for sending and receiving data to/from a remote computer, when the software running on the processor causes the processor to read the gas sensor, if the concentration of the gas is higher than the predetermined threshold for the predetermined period of time, the software causes the processor to control the wireless network interface to send a message indicating an alert to another device through a network.

9. The intelligent wall controller for the garage door opener of claim 8, further comprising after the software causes the processor to control the wireless network interface to send the message indicating the alert to another device through the network, the software causes the processor to wait for another command from the network signaling that the alert is to be reset.

10. The intelligent wall controller for the garage door opener of claim 8, further comprising the software causes the processor to read one or more images from the digital camera or to read a passive infrared sensor, the passive infrared sensor electrically coupled to the processor, and to determine from the one or more images or from the passive infrared sensor if there is movement near the intelligent wall controller and, if it is determined that there is movement, the software causes the processor to control the wireless network interface to send a movement alert message indicating the movement along with the one or more images to the another device through the network.

11. A method of intelligently controlling a garage door opener from a wall controller comprising:
measuring a concentration of a gas in air at the wall controller; and
if the concentration of the gas is greater than a predetermined threshold for a predetermined period of time, determining a state of a garage door by way of video imaging, the garage door being controlled by the garage door opener and if the state is a closed state, signaling the garage door opener to open the garage door.

12. The method of claim 11, wherein the step of determining the state of the garage door comprises reading images from a digital camera, the digital camera interfaced to the wall controller, and analyzing the images to determine the state of the garage door.

13. The method of claim 11, wherein the step of determining the state of the garage door comprises affixing a sticker having a unique icon to an inside surface of the garage door, reading an image from a digital camera, the digital camera interfaced to the wall controller, and analyzing a position of the sticker within the image to determine the state of the garage door.

14. The method of claim 11, further comprises:
after the step of if the concentration of the gas is greater than the predetermined threshold, determining the state of the garage door and if the state is the closed state, signaling the garage door opener to open the garage door, the step of:
communicating with a remote device through a wireless network and sending a transaction indicating an alert to the remote device.

15. The method of claim 12, further comprising determining if there is a movement and, upon detecting of the movement, transmitting video images from the digital camera to a remote device.

16. The method of claim 15, wherein the step of determining if there is the movement comprises reading a passive infrared sensor.

17. An intelligent wall controller for a garage door opener comprising:
a processor;
a carbon monoxide sensor operatively coupled to the processor, the carbon monoxide sensor measures a concentration of carbon monoxide in air around the intelligent wall controller;
an electrically operated switch operatively controlled by the processor, the electrically operated switch electrically connected to a motor unit of the garage door opener;
a digital camera operatively coupled to the processor, images from the digital camera are available for reading by the processor;
software running on the processor causes the processor to read the carbon monoxide sensor and if the concentration of the carbon monoxide is higher than a predetermined threshold for a predetermined period of time, the software causes the processor to read one or more images from the digital camera and to determine from the one or more images if a garage door is closed and, if the garage door is closed, the software causes the processor to control the electrically operated switch to send a command to operate the motor unit of the garage door opener to move the garage door to an open position.

18. The intelligent wall controller for the garage door opener of claim 17, further comprising a sticker attached to an inside surface of the garage door and wherein the software causes the processor to determine from the one or more images if the garage door is closed by way of a position of the sticker.

19. The intelligent wall controller for the garage door opener of claim 17, further comprising a switch, the software causes the processor to detect an operation of the switch and upon detecting the operation of the switch, the software causes the processor to control the electrically operated switch to send the command to operate the motor unit of the garage door opener to move the garage door to an opposing position.

20. The intelligent wall controller for the garage door opener of claim 17, further comprising a wireless network interface, the wireless network interface is operatively coupled to the processor for sending and receiving data to/from a remote computer, when the software running on the processor causes the processor to read the carbon monoxide sensor, if the concentration of the carbon monoxide is higher than the predetermined threshold for the predetermined period of time, the software causes the processor to control the wireless network interface to send an alert to another device through a network.
